(19) United States
(12) Patent Application Publication
(10) Pub. No.: US 2017/0203685 A1
(43) Pub. Date: Jul. 20, 2017

(54) ROAD SURFACE ILLUMINATION APPARATUS

(71) Applicant: MITSUBISHI ELECTRIC CORPORATION, Tokyo (JP)

(72) Inventors: Masato HIRAI, Tokyo (JP); Reiko SAKATA, Tokyo (JP); Akiko IMAISHI, Tokyo (JP); Masami AIKAWA, Tokyo (JP); Kei KASUGA, Tokyo (JP); Hidebumi ARAI, Tokyo (JP); Yumiko OCHIAI, Tokyo (JP)

(73) Assignee: MITSUBISHI ELECTRIC CORPORATION, Tokyo (JP)

(21) Appl. No.: 15/327,829

(22) PCT Filed: Aug. 19, 2014
(86) PCT No.: PCT/JP2014/071656

§ 371 Date: Jan. 20, 2017

(51) Int. Cl. B60Q 1/50; B60Q 1/00; B60Q 1/24; B60Q 1/02

(52) U.S. Cl. CPC B60Q 1/50; B60Q 1/02; B60Q 1/0023; B60Q 1/24; B60Q 2400/50

(57) ABSTRACT

Because a road surface illumination apparatus is configured so as to include a vehicle motion predictor 2 to predict the motion which a vehicle is going to perform from now on in accordance with vehicle information acquired by a vehicle information acquisition unit 1, and a light animation setting unit 3 to set a light animation expressing the motion predicted by the vehicle motion predictor 2, and to cause an illumination device 4 to illuminate a road surface with the animation before the vehicle performs the motion, the road surface illumination apparatus can intuitively notify the motion which the vehicle is going to perform from now on to persons outside the vehicle.

### TECHNICAL FIELD

The present invention relates to a road surface illumination apparatus that illuminates a road surface around a vehicle with light.

### BACKGROUND ART

Conventionally, as a method of notifying the motion of a vehicle to others outside the vehicle, a technique of illuminating a road surface with laser light has been provided.

For example, Patent Literature 1 discloses a method of determining both a possibility that a vehicle starts moving, and a direction in which the vehicle starts moving, and illuminating an area ahead of or behind the vehicle with laser light before the vehicle starts moving.

Further, for example, Patent Literature 2 discloses a method of changing the pattern of a light beam with which a road surface is illuminated in accordance with a vehicle behavior state, such as whether a vehicle is standing, starts moving, is accelerating, is traveling at a very low speed, or is traveling at a high speed. For example, when the vehicle travels at a very low speed, a road surface in the vicinity of the vehicle is illuminated with a visible light pattern having a short length in the traveling direction of the vehicle, whereas when the vehicle travels at a high speed, a road surface far away from the vehicle is illuminated with a visible light pattern having a long length in the traveling direction of the vehicle.

### CITATION LIST

### Patent Literature

Patent Literature 1: Japanese Patent Application Publication No. 2009-40236

Patent Literature 2: Japanese Patent Application Publication No. 2003-231450

### SUMMARY OF INVENTION

### Technical Problem

However, the problem with the method disclosed in Patent Literature 1 is that, even if laser light is applied before the vehicle starts moving, a notification indicating what kind of motion the vehicle is going to perform cannot be provided to others if they cannot understand the meaning of the light. For example, even if a road surface is illuminated with uniform laser light, as shown in Patent Literature 1, others do not understand intuitively that the illumination means that the vehicle is going to move theretoward.

Further, a problem with the method disclosed in Patent Literature 2 is that because the visible light pattern with which a road surface is illuminated is changed in accordance with the vehicle speed, by, for example, decreasing the length of the visible light pattern when the vehicle travels at a very low speed, or increasing the length of the visible light pattern when the vehicle travels at a high speed, but the visible light pattern is changed in accordance with the speed at which the vehicle is traveling, others cannot predict the future motion of the vehicle even if they look at the visible light pattern.

The present invention is made in order to solve the above-mentioned problems, and it is therefore an object of the present invention to provide a technique of intuitively notifying the motion which a vehicle is going to perform from now on to persons outside the vehicle.

### Solution to Problem

According to the present invention, there is provided a road surface illumination apparatus which includes: a vehicle information acquisition unit configured to acquire vehicle information from vehicle-mounted equipment mounted in a vehicle; a vehicle motion predictor configured to predict the motion which the vehicle is going to perform from now on in accordance with the vehicle information acquired by the vehicle information acquisition unit; and a light animation setting unit configured to set a light animation expressing the motion predicted by the vehicle motion predictor, and configured to cause an illumination device mounted in the vehicle to illuminate a road surface with the animation before the vehicle performs the motion.

### Advantageous Effects of Invention

Because before the vehicle performs a motion, the road surface illumination apparatus according to the present invention illuminates a road surface with a light animation expressing the motion, the road surface illumination apparatus can intuitively notify the motion which the vehicle is going to perform from now on to persons outside the vehicle.

### BRIEF DESCRIPTION OF DRAWINGS

FIG. 1 is a block diagram showing the configuration of a road surface illumination apparatus according to Embodiment 1 of the present invention;

FIG. 2 is a flow chart showing the operation of the road surface illumination apparatus according to Embodiment 1;

FIGS. 3A to 3D are diagrams showing a light animation with which a road surface is illuminated by the road surface illumination apparatus according to Embodiment 1, and show an example when a vehicle starts its engine;

FIGS. 4A to 4C are diagrams showing a light animation with which a road surface is illuminated by the road surface illumination apparatus according to Embodiment 1, and show an example when the position of a shift lever has been moved from “P” to “D”;

FIGS. 5A to 5D are diagrams showing alight animation with which a road surface is illuminated by the road surface illumination apparatus according to Embodiment 1, and show an example when the vehicle has started moving forward;

FIGS. 6A to 6F are diagrams showing a light animation with which a road surface is illuminated by the road surface illumination apparatus according to Embodiment 1, and show a variant when the position of the shift lever has been moved from “P” to “D”;

FIGS. 7A to 7D are diagrams showing a light animation with which a road surface is illuminated by the road surface illumination apparatus according to Embodiment 1, and show a variant when the vehicle has started moving forward;

FIG. 8 is a diagram showing a light animation with which a road surface is illuminated by the road surface illumination apparatus according to Embodiment 1, and shows an example when a steering wheel turns at a time when the vehicle moves forward;

FIGS. 9A to 9D are diagrams showing a light animation with which a road surface is illuminated by the road surface illumination apparatus according to Embodiment 1, and show an example when the vehicle starts its engine;

FIGS. 10A to 10F are diagrams showing a light animation with which a road surface is illuminated by the road surface illumination apparatus according to Embodiment 1, and show an example when the position of the shift lever has been moved from “P” to “R”;

FIGS. 11A to 11C are diagrams showing a light animation with which a road surface is illuminated by the road surface illumination apparatus according to Embodiment 1, and show an example when the vehicle starts moving backward;

FIGS. 12A to 12D are diagrams showing a light animation with which a road surface is illuminated by the road surface illumination apparatus according to Embodiment 1, and show an example when the position of the shift lever has been moved from “R” to “P” or “D”;

FIG. 13 is a diagram showing a light animation with which a road surface is illuminated by the road surface illumination apparatus according to Embodiment 1, and shows an example when the steering wheel turns at a time when the vehicle moves backward;

FIGS. 14A to 14E are diagrams showing a light animation with which a road surface is illuminated by the road surface illumination apparatus according to Embodiment 1, and show an example when a passenger in the vehicle is going to open a door;

FIGS. 15A to 15E are diagrams showing a light animation with which a road surface is illuminated by the road surface illumination apparatus according to Embodiment 1, and show an example when the doors are unlocked by using a keyless entry system;

FIG. 16 is a block diagram showing the configuration of a road surface illumination apparatus according to Embodiment 2 of the present invention;

FIG. 17 is a flow chart showing the operation of the road surface illumination apparatus according to Embodiment 2;

FIGS. 18A and 18B are diagrams showing a light animation with which a road surface is illuminated by the road surface illumination apparatus according to Embodiment 2, and show an example when a person exists ahead of a vehicle;

FIGS. 19A and 19B are diagrams showing a light animation with which a road surface is illuminated by the road surface illumination apparatus according to Embodiment 2, and show an example when no person exists ahead of the vehicle; and

FIGS. 20A and 20B are diagrams each showing a light animation with which a road surface is illuminated by the road surface illumination apparatus according to Embodiment 2, and FIG. 20A shows an example when a person exists to the right of the vehicle and FIG. 20B shows an example when persons respectively exist to the left and right of the vehicle.

### DESCRIPTION OF EMBODIMENTS

Hereafter, in order to explain this invention in greater detail, the preferred embodiments of the present invention will be described with reference to the accompanying drawings.

### Embodiment 1

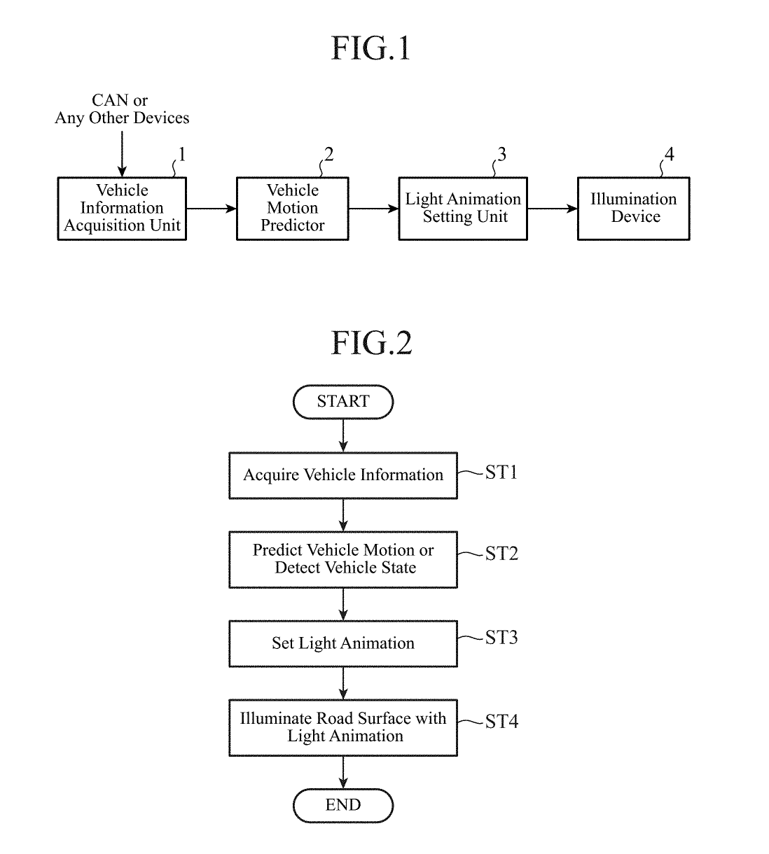

As shown in FIG. 1, a road surface illumination apparatus according to Embodiment 1 includes a vehicle information acquisition unit 1, a vehicle motion predictor 2 and a light animation setting unit 3, and illuminates an area around a vehicle with visible light from an illumination device 4 mounted in the vehicle. This road surface illumination apparatus is configured with a CPU (Central Processing Unit), a memory and so on, and performs the functions of the vehicle information acquisition unit 1, the vehicle motion predictor 2 and the light animation setting unit 3 by executing a program. The illumination device 4 is a laser or the like mounted in the vehicle, and illuminates a road surface under the vehicle and a road surface around the vehicle with visible light, to display a graphic or the like.

The vehicle information acquisition unit 1 acquires vehicle information either from other vehicle-mounted equipment via an in-vehicle network, such as a CAN (Controller Area Network), or directly from other vehicle-mounted equipment. For example, as the vehicle information, CAN data (information about operations such as operations on a blinker, a steering wheel, an accelerator, a brake, a handbrake, and a shift lever), information detected by a touch sensor, such as one attached to a door handle, information about locking or unlocking of doors by using a keyless entry system, etc. are used.

The vehicle information acquisition unit 1 outputs the vehicle information acquired thereby to the vehicle motion predictor 2.

The vehicle motion predictor 2 predicts the motion which the vehicle is going to perform in accordance with the vehicle information received from the vehicle information acquisition unit 1. For example, the motion which the vehicle is going to perform is the one of moving forward from a standing state, the one of moving backward from the standing state, or the one of opening a door. For example, when sensing that the position of the shift lever has been moved from “P (parking)” to “D (drive)”, and the handbrake has been turned “off”, in accordance with the vehicle information, the vehicle motion predictor 2 predicts that the vehicle is going to move forward from the standing state. Further, when sensing that the vehicle is in the standing state, and a passenger has touched a door handle within the cabin, the vehicle motion predictor 2 predicts that a passenger is going to open the door.

Further, the vehicle motion predictor 2 can not only predict the motion of the vehicle, but also determine the state of the vehicle (e.g., a state in which the doors have been unlocked by using the keyless entry system).

The vehicle motion predictor 2 outputs the information about the predicted vehicle motion to the light animation setting unit 3. Not only the predicted motion of the vehicle but also the state of the vehicle can be included in the vehicle motion information.

The light animation setting unit 3 sets alight animation with which a road surface is to be illuminated, in accordance with the vehicle motion information received from the vehicle motion predictor 2. The light animation is light expressing a graphic for intuitively notifying the motion of the vehicle by using an animation. For example, the light animation is the one which is applied when the vehicle is going to move forward from the standing state, the one which is applied when the vehicle is going to move backward from the standing state, or the one which is applied when a door is going to be opened. The light animation setting unit 3 outputs the light animation set thereby to the illumination device 4.

The light animation setting unit 3 can hold light animations provided for vehicle motions, and select a light animation from among the light animations in accordance with the vehicle motion information received from the vehicle motion predictor 2.

The illumination device 4 illuminates a road surface with the light animation received from the light animation setting unit 3. Although a method of projecting laser light onto a road surface, or the like can be considered as a method of illuminating a road surface with the light animation, this embodiment is limited to this method.

Next, the operation of the road surface illumination apparatus will be explained using a flow chart shown in FIG. 2.

First, in step ST1, the vehicle information acquisition unit 1 acquires the vehicle information from the vehicle and outputs the vehicle information to the vehicle motion predictor 2. For example, the vehicle information acquisition unit 1 acquires the vehicle information showing that the position of the shift lever has been moved from “P” to “D”, and the handbrake has been turned “off.”

The vehicle motion predictor 2, in step ST2, predicts the motion of the vehicle in accordance with the vehicle information, and outputs the vehicle motion information to the light animation setting unit 3. For example, when the vehicle information shows what the position of the shift lever has been moved from “P” to “D”, and the handbrake has been turned “off”, the vehicle motion predictor 2 predicts that the vehicle is going to move forward from the standing state.

The vehicle motion predictor 2 can not only predict the motion of the vehicle, but also determine the state of the vehicle (e.g., a state in which the doors have been unlocked by using the keyless entry system).

The light animation setting unit 3, in step ST3, sets a light animation in accordance with the vehicle motion information, and outputs the light animation to the illumination device 4. For example, when the vehicle motion information shows that the vehicle is going to move forward from the standing state, the light animation setting unit 3 sets a light animation for forward movement.

The illumination device 4, in step ST4, illuminates a road surface with the light animation received from the light animation setting unit 3.

The road surface illumination apparatus can instruct a vehicle-mounted speaker to output a sound suited to the light animation when illuminating the road surface with the light animation. At this time, the road surface illumination apparatus can output the sound toward the driver and others existing within the vehicle, or output the sound toward persons outside the vehicle.

The road surface illumination apparatus repeatedly carries out processing shown in a flow chart of FIG. 2 at regular intervals.

Next, light animations will be explained.

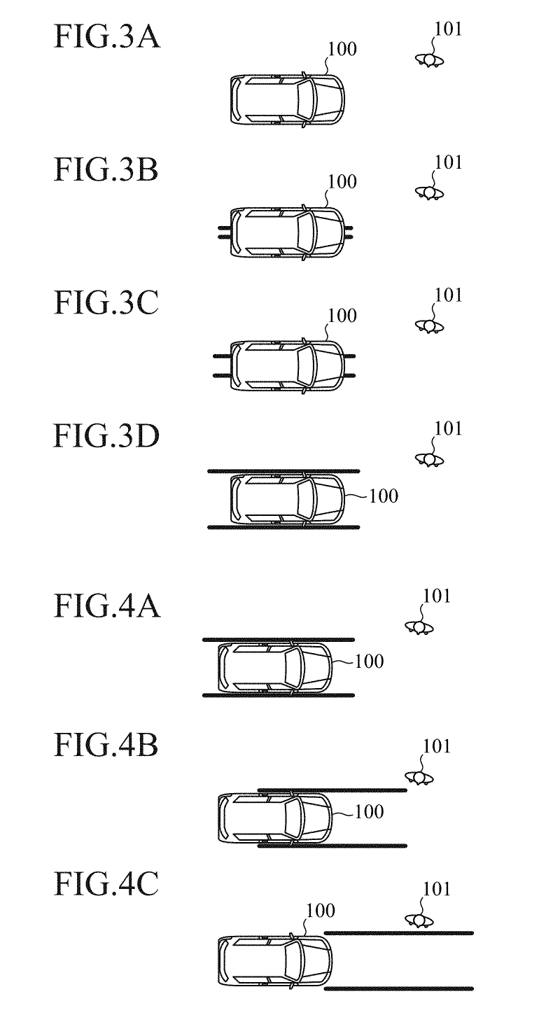

First, examples of light animations when the vehicle is going to move forward from the standing state will be explained with reference to FIGS. 3 to 5.

FIGS. 3A to 3D show a light animation when the vehicle 100 starts the engine. FIG. 3A shows a state in which the vehicle 100 is standing with the engine being off. A person 101 is existing in a front left area in the vicinity of the vehicle 100. When the engine is started, the road surface illumination apparatus acquires the vehicle information indicating that the engine has been started, predicts that the vehicle is going to start moving, and sets a light animation. The illumination device 4 then illuminates a road surface in the vicinity of the vehicle with the light animation which varies from that shown in FIG. 3B to that shown in FIG. 3C, and then to that shown in FIG. 3D. In this example, a road surface facing the vehicle 100 is illuminated with the light animation in a form in which two straight lines extending in the longitudinal direction of the vehicle are arranged in parallel to each other with them being close to each other (FIG. 3B), and these two straight lines move away from each other to positions just outside both sides of the vehicle 100 in approximately 0.5 seconds (FIG. 3D). By causing the two straight lines to move away from each other to positions just outside both the sides of the vehicle 100, the area occupied by the single vehicle is expressed.

This light animation expresses that life has been breathed into the vehicle because of the start of the engine of the vehicle 100. Asa result, the road surface illumination apparatus can provide, to the nearby person 101, a notification of the state indicating that the vehicle is capable of moving after the engine has been started.

The light animation shown in FIGS. 3A to 3D is an example, any light animation having another expression can be alternatively used as long as the animation can express either that the vehicle is capable of moving after the engine has been started, or that life has been breathed into the vehicle.

FIGS. 4A to 4C show a light animation when the position of the shift lever of the vehicle 100 has been moved from “P” to “D.” In a state shown in FIG. 4A, the road surface illumination apparatus acquires the vehicle information showing that the position of the shift lever has been moved from “P” to “D”, predicts that the vehicle is going to move forward, and sets a light animation. The illumination device 4 illuminates a road surface with the light animation in which two straight lines applied to positions just outside both the sides of the vehicle 100 move forward a distance equal to the length of the single vehicle, the light animation varying from that shown in FIG. 4A to that shown in FIG. 4B, and then to that shown in FIG. 4C. The two straight lines applied to the positions shown in FIG. 4A are caused to move to the positions shown in FIG. 4C in approximately 1 second. As an alternative, the two straight lines can be caused to move at the same speed as the vehicle speed at the time that the standing vehicle starts moving forward. It is assumed that information about the vehicle width, the vehicle total length, the typical speed at the time that the vehicle starts moving forward, and so on is held in advance by the light animation setting unit 3.

Because the two straight lines with which the road surface is illuminated express the vehicle width of the vehicle 100 and the area occupied by the single vehicle, the nearby person 101 can intuitively predict that the vehicle 100 is going to move forward from the forward movement of the two straight lines.

Further, the person 101 existing ahead of the vehicle 100 can also sense a message showing that the person must not cross the street in front of the vehicle 100 because the two straight lines expressing the vehicle width gets longer toward a road surface in the vicinity of his or her feet.

The light animation shown in FIGS. 4A to 4C is an example, and any light animation having another expression can be alternatively used as long as the animation can express that the vehicle is going to move forward.

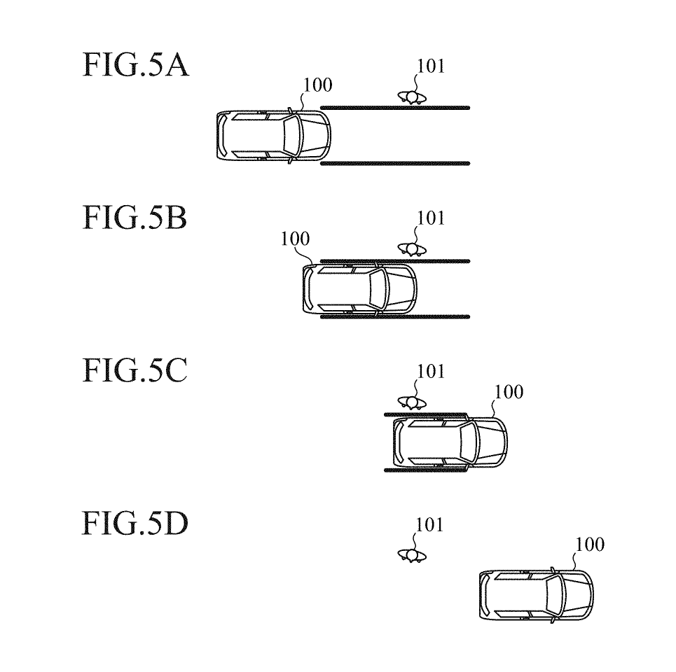

FIG. 5 shows a light animation when the vehicle 100 has started moving forward. When the vehicle 100 moves forward while changing from a state of FIG. 5A, via states of FIGS. 5B and 5C, to a state of FIG. 5D, the road surface illumination apparatus applies a light animation in which two straight lines with which a road surface ahead of the vehicle 100 has been illuminated are fixedly displayed at their positions, so that the vehicle 100 will travel above the area between the straight lines. At that time, the road surface illumination apparatus acquires the vehicle information indicating the speed at which the vehicle 100 moves forward, predicts the positions of the vehicle 100, and sets the light animation to thereby cause the two straight lines to disappear together with the passage of the rear portion of the vehicle 100. As a result, when the vehicle 100 has passed above the light animation (FIG. 5D), all of the light with which the road surface is illuminated disappears. Because the light with which the road surface is illuminated disappears with the passage of the vehicle 100, there is provided an advantage of being able to direct a method of extinguishing the light without causing the person to have a feeling that something is unusual. Further, because the road surface illumination apparatus applies the light animation only when the vehicle starts moving forward, and does not apply any light animation while the vehicle is traveling, there is provided an advantage of preventing the whole town from being full of light while the vehicle is traveling.

In the above-mentioned example, the road surface illumination apparatus enables the person 101 to predict and recognize the motion which the vehicle is going to perform from now on, by providing the expression (animation) of the light which varies from FIG. 3B, via FIG. 3C, to FIG. 3D and the expression of the light which varies from FIG. 4A, via FIG. 4B, to FIG. 4C. The road surface illumination apparatus provides an action of enabling persons to assume the motion of the vehicle by processing the light with which a road surface is to be illuminated to generate an animation having a motion, and an advantage of enabling persons to intuitively predict the motion of the vehicle only by looking at the light.

Further, in the case of the light animation shown in FIGS. 3A to 3D, the two straight lines with which the side areas in the vicinity of the vehicle 100 are illuminated also protrude a little from the rear of the vehicle. In the case of the light animation shown in FIGS. 4A to 4C, the light protruding from the rear of the vehicle moves toward an area ahead of the vehicle. As a result, persons existing behind the vehicle can intuitively predict that the vehicle 100 is not going to come theretoward.

The light animations applied at the time that the vehicle starts moving forward, which are introduced in the above-mentioned example, are an example, and light animations other than those in the above-mentioned example can be used. Further, by changing the color of the illumination light, a notification of the motion of each of the light animations can be effectively provided to persons outside the vehicle. In addition, a sound can be outputted together with each of the light animations.

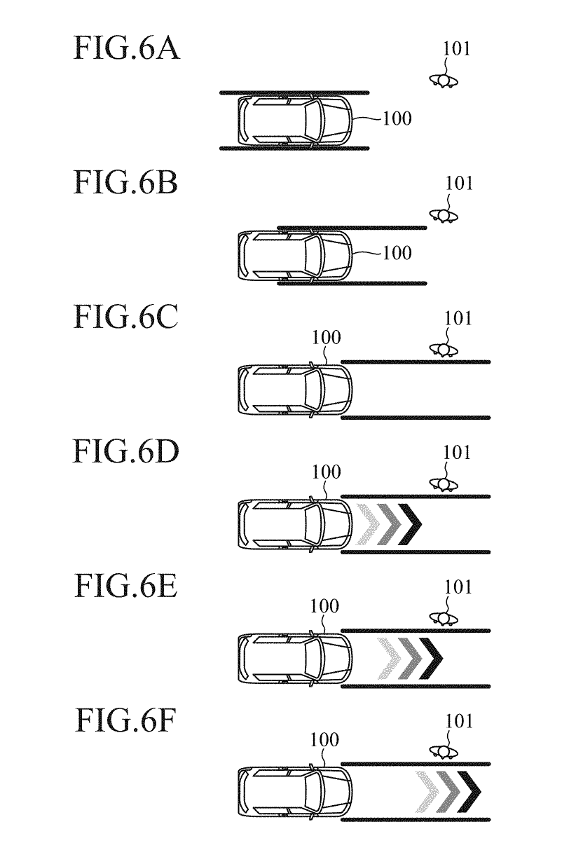

Next, another example of the expression of the light animation when the position of the shift lever of the vehicle 100 has been moved from “P” to “D” will be explained with reference to FIGS. 6A to 6F. In the example of FIGS. 6A to 6F, by adding an animation in which light flows to the light animation shown in FIGS. 4A to 4C, the road surface illumination apparatus can emphasize that the vehicle 100 is going to move forward, and cause a person 101 outside the vehicle to intuitively have a premonition that the vehicle is going to move forward.

The illumination device 4 moves two straight lines with which road surfaces to the left and right of the vehicle 100 are illuminated toward an area ahead of the vehicle in such a way that the two straight lines vary from those shown in FIG. 6A, via those shown in FIG. 6B, to those shown in FIG. 6C, and, after that, further illuminates a front road surface with a graphic, such as arrows pointing in the forward direction, and repeatedly applies an animation in which three arrows flow in the forward direction in such a way that the arrows vary from those shown in FIG. 6D, via those shown in FIG. 6E, to those shown in FIG. 6F. By causing the arrows to move at the same speed as the speed at which the standing vehicle starts moving forward, the road surface illumination apparatus can express a realistic feeling.

The road surface illumination apparatus expresses the traveling direction of the vehicle 100 with the light and the motion of the three arrows, and also expresses the place where the vehicle is going to pass through with the expression of the vehicle width using the two straight lines.

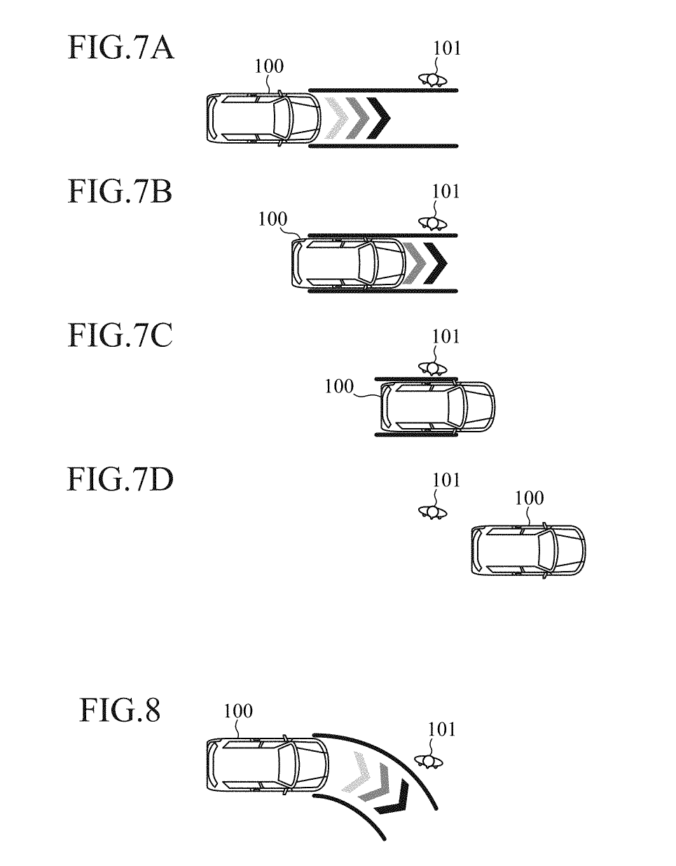

FIGS. 7A to 7D show a case in which the vehicle 100 has started moving forward in a state in which the road surface illumination apparatus applies the light animation shown in FIGS. 6A to 6F. As shown in FIGS. 7A to 7D, when the vehicle 100 passes over the light animation, the road surface illumination apparatus causes the two straight lines and the three arrows to disappear together at the time that the rear portion of the vehicle passes in front of the person.

Next, an example of a light animation when the steering wheel of the vehicle 100 turns will be explained with reference to FIG. 8. When the position of the shift lever of the vehicle 100 has been moved from “P” to “D”, or when the vehicle 100 has started moving forward, the road surface illumination apparatus predicts the path along which the vehicle is going to travel in response to the vehicle information showing that the steering wheel has turned, and sets a light animation which is shaped into a graphic curved along the path. The illumination device 4 then illuminates a road surface with the light animation in which two straight lines (e.g., those shown in FIG. 6A) applied to positions just outside both the sides of the vehicle 100 move along the path while bending (FIG. 8). After that, the illumination device can repeatedly apply an animation in which arrows expressing the traveling direction flow along the path while bending, to between the two straight lines.

By providing this light animation, the road surface illumination apparatus can notify persons around the vehicle that the vehicle is going to move forward while turning.

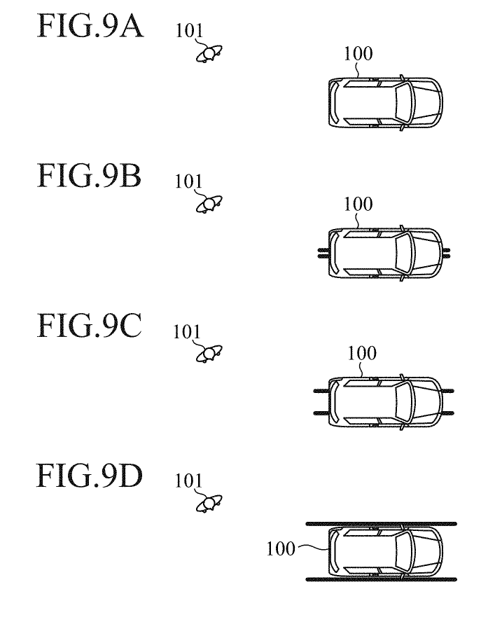

Next, an example of light animations when the vehicle is going to move backward from the standing state will be explained with reference to FIGS. 9 to 11.

FIGS. 9A to 9D show an example of a light animation when the vehicle 100 starts the engine. FIG. 9A shows a state in which the vehicle 100 is standing with the engine being off. A person 101 is existing in a rear left area in the vicinity of the vehicle 100. When the engine is started, the road surface illumination apparatus illuminates a road surface with the light animation which varies from that shown in FIG. 9B to that shown in FIG. 9C, and then to that shown in FIG. 9D. This light animation is the same as that shown in FIGS. 3A to 3D.

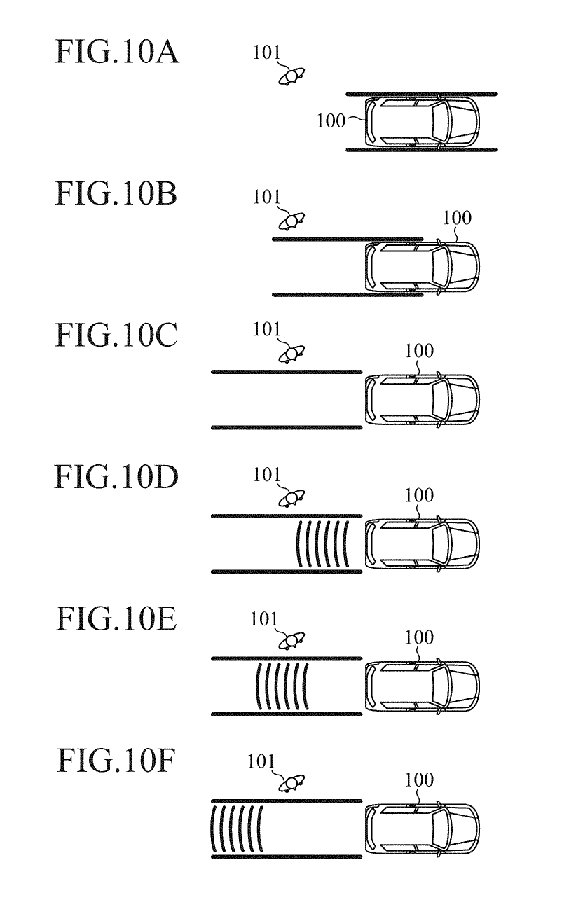

FIGS. 10A to 10F show an example of a light animation when the position of the shift lever of the vehicle 100 has been moved from “P” to “R (reverse).” In a state shown in FIG. 10A, the road surface illumination apparatus acquires the vehicle information showing that the position of the shift lever has been moved from “P” to “R”, predicts that the vehicle is going to move backward, and sets a light animation. The light animation at the time that the vehicle moves backward is the one in which two straight lines, instead of the two straight lines shown in FIGS. 4A to 4C, move toward an area behind the vehicle instead of an area ahead of the vehicle. More specifically, the two straight lines applied to positions just outside both the sides of the vehicle 100 move backward a distance equal to the length of the single vehicle, the light animation varying from that shown in FIG. 10A to that shown in FIG. 10B, and then to that shown in FIG. 10C.

Further, like in the case of the light animation shown in FIGS. 6A to 6F, the road surface illumination apparatus further illuminates a rear road surface with a graphic, such as bow-shaped lines pointing in the backward direction, and repeatedly applies an animation in which six bow-shaped lines flow in the backward direction in such a way that the bow-shaped lines vary from those shown in FIG. 10D, via those shown in FIG. 10E, to those shown in FIG. 10F. Further, by causing the bow-shaped lines to move at the same speed as the speed at which the standing vehicle starts moving backward, the road surface illumination apparatus can express a realistic feeling. It is assumed that the light animation setting unit 3 holds information about a typical speed, etc. at the time that the vehicle starts moving backward.

The road surface illumination apparatus expresses the traveling direction of the vehicle 100 with the light and the motion of the six bow-shaped lines, and also expresses the place where the vehicle is going to pass through with the expression of the vehicle width using the two straight lines.

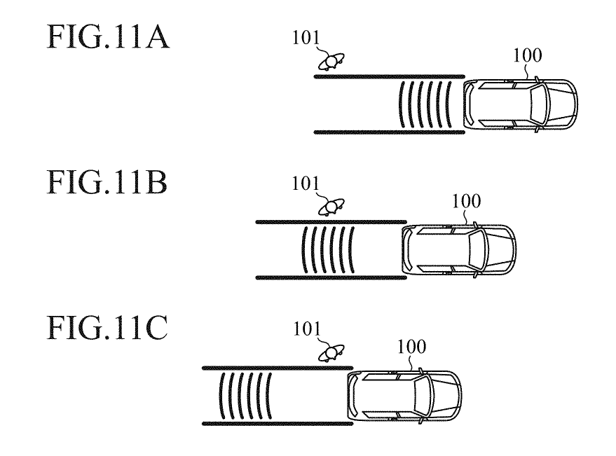

FIGS. 11A to 11C show an example of alight animation when the vehicle 100 has started moving backward. When the vehicle 100 moves backward while changing from a state of FIG. 11A, via a state of FIG. 11B, to a state of FIG. 11C, the road surface illumination apparatus repeatedly illuminates the rear road surface with the same light animation as that shown in FIGS. 10D to 10F.

While in the case of the light animation (FIGS. 7A to 7D) at the time that the vehicle moves forward, the road surface illumination apparatus extinguishes the light as the vehicle 100 moves forward, in the case of the light animation (FIGS. 11A to 11C) at the time that the vehicle moves backward, the road surface illumination apparatus repeatedly applies the light animation without extinguishing the light. While it is difficult for the driver to check the traveling direction during backward movements, unlike in the case of forward movements, the present embodiment provides an advantage of being able to continue notifying persons around the vehicle at all times that the vehicle is moving backward.

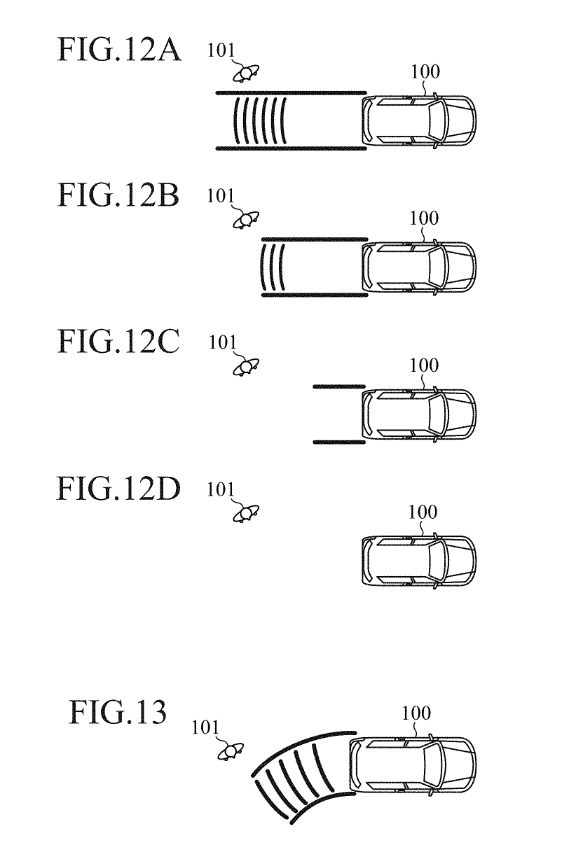

Next, an example of a light animation when the position of the shift lever of the vehicle 100 has been moved from “R” to “P”, “D” or the like will be explained with reference to FIGS. 12A to 12D. In a state shown in FIG. 12A, the road surface illumination apparatus acquires the vehicle information showing that the position of the shift lever has moved from “R” to “P”, “D” or the like, predicts that the vehicle is not going to move backward anymore, and sets alight animation expressing that the vehicle is going to stop moving backward. When the vehicle stops moving backward, although the road surface illumination apparatus can simply extinguish the light of the two straight lines and the six bow-shaped lines from the illumination device 4 with which the rear road surface has been illuminated, the road surface illumination apparatus applies an animation in which the light is extinguished gradually from apart thereof distant from the vehicle 100 toward a part thereof in the vicinity of the vehicle 100 in such a way that the light varies from that shown in FIG. 12A, via those shown in FIGS. 12B and 12C, to that shown in FIG. 12D, thereby being able to emphasizedly express that the vehicle is going to stop moving backward.

Next, an example of a light animation when the steering wheel of the vehicle 100 turns will be explained with reference to FIG. 13. When the position of the shift lever of the vehicle 100 has been moved from “P” to “R”, or when the vehicle 100 has started moving backward, the road surface illumination apparatus predicts the path along which the vehicle is going to travel in response to the vehicle information showing that the steering wheel has turned, and sets a light animation which is shaped into a graphic curved along the path as shown in FIG. 13.

The light animations applied at the time that the vehicle starts moving backward, which are introduced in the above-mentioned example, are an example, and light animations other than those in the above-mentioned example can be used. Further, by changing the color of the illumination light, a notification of the motion of each of the light animations can be effectively provided to persons outside the vehicle. Further, in order to make a distinction between a forward movement and a backward movement intelligible, for example, the road surface illumination apparatus can change the color of the light animation to green at a time of a forward movement and the color of the light animation to red at a time of a backward movement. In addition, in order to make a backward movement more noticeable, the animation can be combined with a blinking animation in which illumination light blinks, or a moving animation. A moving animation is one in which there is a flow as expressed in, for example, FIGS. 10D, 10E and 10F.

In addition, a sound can be outputted together with each of the light animations.

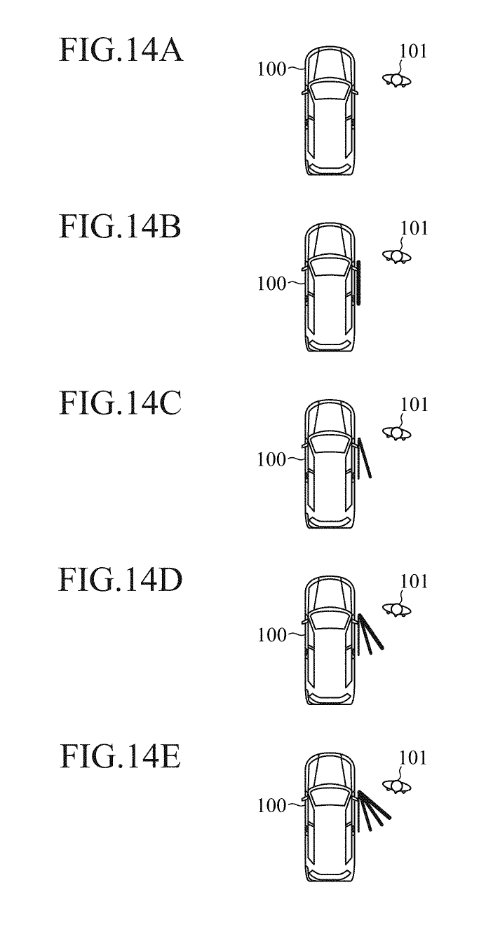

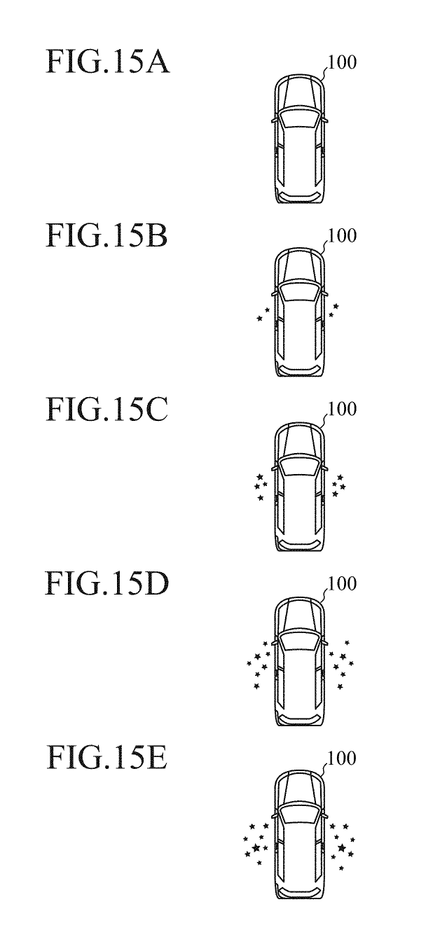

Next, an example of a light animation when a passenger within the vehicle is going to open a door will be explained with reference to FIGS. 14A to 14E.

FIG. 14A shows a state in which the vehicle 100 is standing. A person 101 is existing in an area to the right of the vehicle 100. A touch sensor or the like is mounted in each door handle within the cabin of the vehicle 100, and a detection result acquired by the sensor is outputted to the road surface illumination apparatus as vehicle information. The road surface illumination apparatus acquires the vehicle information showing a state in which a passenger has touched a door handle, predicts that the door is going to be opened, and sets a light animation having a motion which causes persons to imagine the opening or closing of the door. The illumination device 4 then illuminates a road surface under the door with the light animation expressing the locus of a straight line imitating the door and opening in the shape of a fan, the light animation varying from that shown in FIG. 14B, via those shown in FIGS. 14C and 14D, to that shown in FIG. 14E. By thus applying the light animation having a motion which causes persons to imagine the opening or closing of a door, there is provided an advantage of enabling the nearby person 101 to intuitively predict that a passenger in the vehicle 100 is going to open the door from now on only by looking at the light animation. Because the nearby person 101 can notice in advance that the door of the vehicle 100 is going to be opened, there is provided another advantage of enabling the person to avoid passing by the door of the vehicle by bicycle.

In a case in which this light animation is applied to the automatic door for the rear seat of a taxi, the road surface illumination apparatus can prevent motorbikes, bicycles, etc. from passing through between the taxi and the road shoulder. Further, the road surface illumination apparatus can notify a passenger who is about to get into the taxi from now on in advance that the door is going to be opened.

Next, an example of a light animation when the doors have been unlocked by using the keyless entry system will be explained with reference to FIGS. 15A to 15E.

FIG. 15A shows a state in which the vehicle 100 is standing. When a passenger, such as the driver, unlocks the doors of the vehicle 100 from outside the vehicle, by using the keyless entry system, the vehicle information showing that the doors have been unlocked is outputted to the road surface illumination apparatus. The road surface illumination apparatus acquires the vehicle information, determines that the vehicle enters a state in which the doors have been unlocked, and sets a light animation which is directed to give passengers a warm welcome. The illumination device 4 then illuminates road surfaces under the doors with the light animation having a graphic such as star marks, to shine the road surfaces glitteringly, the light animation varying from that shown in FIG. 15B, via those shown in FIGS. 15C and 15D, to that shown in FIG. 15E. As an alternative, the illumination device can illuminate road surfaces under the doors with spotlight-like beams. In addition, the illumination device can illuminate not only road surfaces to the left and right of the vehicle 100 but also road surfaces ahead of and behind the vehicle, with the light animation. Further, a sound can be outputted together with the light animation.

By applying such the light animation, the road surface illumination apparatus can provide direction to give passengers within the vehicle 100 a warm welcome. Further, there is provided an advantage of making it easy for passengers to find the vehicle 100.

In a case in which this light animation is applied to a taxi, there is provided an advantage of being able to express an intention to giving passengers a warm welcome.

As mentioned above, the road surface illumination apparatus according to Embodiment 1 is configured so as to include the vehicle information acquisition unit 1 to acquire vehicle information from vehicle-mounted equipment mounted in a vehicle, the vehicle motion predictor 2 to predict the motion which the vehicle is going to perform from now on in accordance with the vehicle information acquired by the vehicle information acquisition unit 1, and the light animation setting unit 3 to set a light animation expressing the motion predicted by the vehicle motion predictor 2, and to cause the illumination device 4 to illuminate a road surface with the animation before the vehicle performs the motion, the road surface illumination apparatus can intuitively notify the motion which the vehicle is going to perform from now on to persons outside the vehicle. Persons outside the vehicle are enabled to predict the motion of the vehicle from the light animation with which the road surface is illuminated.

Further, because the road surface illumination apparatus according to Embodiment 1 is configured in such a way that the vehicle motion predictor 2 determines the state of the vehicle in accordance with the vehicle information acquired by the vehicle information acquisition unit 1, and the light animation setting unit 3 sets a light animation expressing the vehicle state determined by the vehicle motion predictor 2, and causes the illumination device 4 to illuminate a road surface with the light animation, the road surface illumination apparatus can provide direction to give passengers a warm welcome by using the light animation when, for example, the doors have been unlocked by using the keyless entry system.

### Embodiment 2

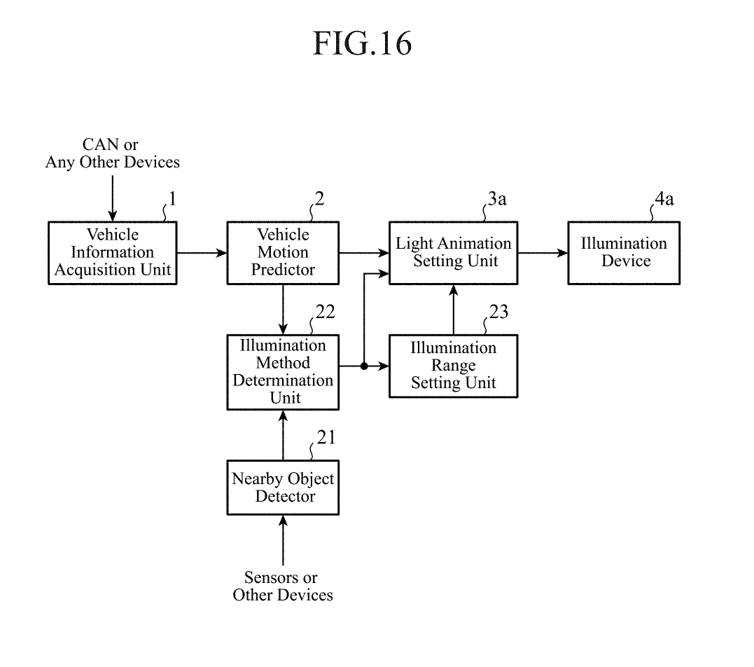

FIG. 16 is a block diagram showing an example of the configuration of a road surface illumination apparatus according to Embodiment 2. In FIG. 16, the same components as those of FIG. 1 or like components are designated by the same reference numerals, and the explanation of the components will be omitted hereafter. The road surface illumination apparatus according to Embodiment 2 is configured so as to additionally include a nearby object detector 21, an illumination method determination unit 22 and an illumination range setting unit 23.

The nearby object detector 21 acquires sensing information from sensors mounted in a vehicle, and detects the positions of pedestrians, other vehicles, etc. (referred to as nearby objects from here on) existing in an area around the vehicle. As a sensing method, there is a method of determining information showing what each nearby object is (e.g., a walking person, a standing person, a child or a vehicle), the direction of and the distance to each nearby object, and other information about each nearby object from an image captured by the imaging sensor of a camera. Further, there is a method of determining information showing what each nearby object is, the direction of and the distance to each nearby object, and other information about each nearby object, by using a photosensor which employs an LED source. Another method can be alternatively used as the sensing method.

The nearby object detector 21 outputs the nearby object information acquired thereby to the illumination method determination unit 22.

The illumination method determination unit 22 determines a method of applying a light animation in accordance with vehicle motion information received from a vehicle motion predictor 2, and the nearby object information received from the nearby object detector 21. For example, the illumination method determination unit determines a method of extending the illuminated range of a light animation toward a direction in which a pedestrian or another vehicle is existing, or making the light animation more noticeable as the light animation gets closer to a pedestrian or another vehicle. In contrast, the illumination method determination unit determines a method of reducing or eliminating the illuminated range of a light animation in a direction in which neither a pedestrian nor another vehicle is existing, or processing a light animation in such a way that the light animation becomes blurred and faint more greatly as the light animation gets closer to a place where neither a pedestrian nor another vehicle is existing.

The illumination method determination unit 22 provides the illumination method determined thereby to a light animation setting unit 3a and the illumination range setting unit 23.

The illumination range setting unit 23 sets the illuminated range of a light animation in accordance with the illumination method determined by the illumination method determination unit 22, and provides the illuminated range as illuminated range information to the light animation setting unit 3a. The light animation setting unit 3a sets a light animation based on the vehicle motion information received from the vehicle motion predictor 2 for the illuminated range based on the illuminated range information received from the illumination range setting unit 23. The light animation setting unit 3a also processes the light animation in accordance with the illumination method determined by the illumination method determination unit 22. For example, the light animation setting unit 3a makes the light animation more noticeable. The illumination device 4a applies the light animation set by the light animation setting unit 3a.

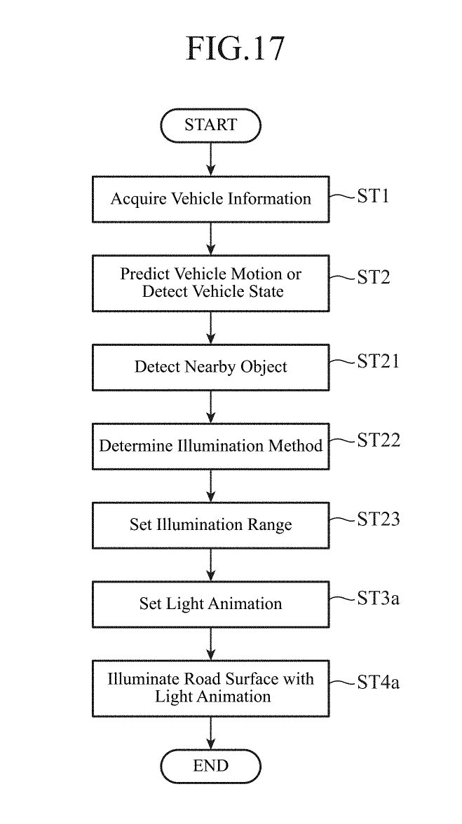

Next, the operation of the road surface illumination apparatus will be explained using a flow chart shown in FIG. 17. Because processes in steps ST1 and ST2 of FIG. 17 are the same as those shown in FIG. 2, the explanation of the processes will be omitted hereafter.

The nearby object detector 21, in step ST21, determines whether a nearby object exists around the vehicle and detects the distance from the vehicle to a nearby object, and so on, in accordance with the sensing information, and outputs the nearby object information to the illumination method determination unit 22.

The illumination method determination unit 22, in step ST22, determines an illumination method for light animations in accordance with the nearby object information, and outputs the illumination method information to the light animation setting unit 3a and the illumination range setting unit 23.

The illumination range setting unit 23, in step ST23, determines the illuminated range of light animations in accordance with the illumination method information, and outputs the illuminated range information to the light animation setting unit 3a. The light animation setting unit 3a, in step ST3a, sets a light animation corresponding to the vehicle motion information, and changes the illuminated range of light animations in accordance with the illuminated range information and changes a method of expressing the light animation in accordance with the illumination method information. The illumination device 4a, in step ST4a, illuminates a road surface with the light animation set by the light animation setting unit 3a.

The road surface illumination apparatus repeatedly carries out processing shown in a flow chart of FIG. 17 at regular intervals.

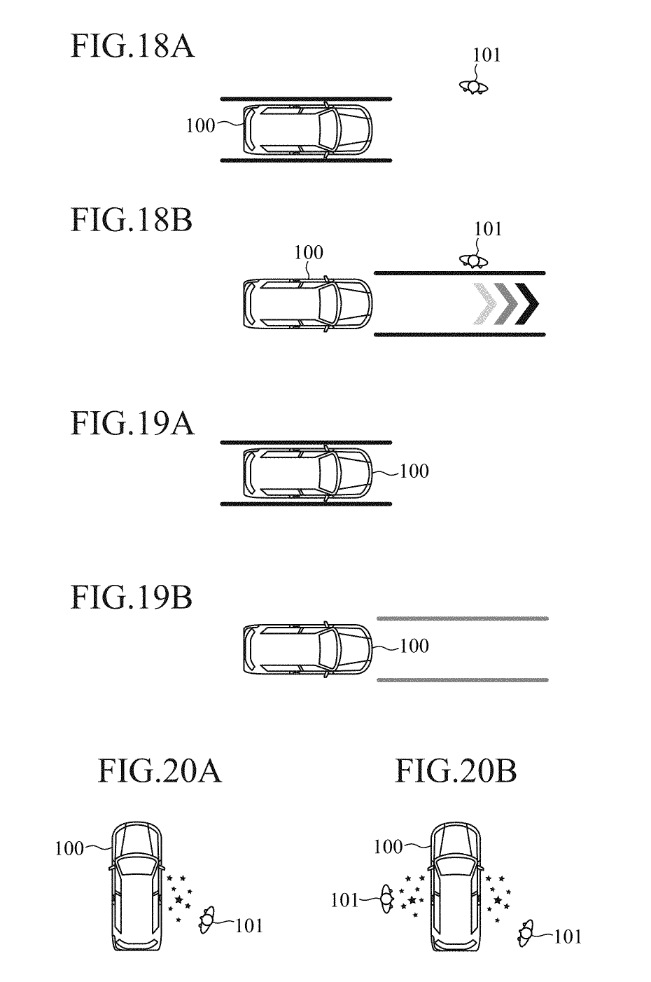

Next, an example of a light animation when the position of a shift lever has been moved from “P” to “D” in order for the vehicle to move forward from a standing state will be explained using FIGS. 18 and 19.

As shown in FIG. 18A, when the nearby object detector 21 of the road surface illumination apparatus detects a person 101 existing in a front left area in the vicinity of the vehicle 100, the illumination method determination unit 22 determines to emphasize a light animation with which an area ahead of the vehicle is to be illuminated. The light animation setting unit 3a sets a light animation, as shown in FIG. 18B, in which arrows showing the traveling direction are added to between two straight lines showing the vehicle width, in accordance with the determination, thereby emphasizing the light animation.

In contrast, when the nearby object detector 21 of the road surface illumination apparatus does not detect any nearby object, such as a person, in an area around the vehicle 100, as shown in FIG. 19A, the illumination method determination unit 22 determines to make a light animation, with which an area ahead of the vehicle is to be illuminated, become faint and hardly noticeable. The light animation setting unit 3a sets a light animation in which two straight lines showing the vehicle width are faint and hardly noticeable, as shown in FIG. 19B, in accordance with the determination. In this example, although the light animation is set in such a way as to be faint and hardly noticeable, the light of the animation can be alternatively extinguished.

Next, an example of a light animation when the doors are unlocked by using a keyless entry system will be explained with reference to FIGS. 20A and 20B.

As shown in FIG. 20A, when the nearby object detector 21 of the road surface illumination apparatus detects a person 101 existing in a right area in the vicinity of the vehicle 100, the illumination method determination unit 22 determines to illuminate only a right area in the vicinity of the vehicle in which the person 101 is existing with a light animation. The illumination range setting unit 23 sets the illuminated range to a road surface under the doors on the right side of the vehicle in accordance with the determination. Therefore, the road surface under the doors on the right side of the vehicle is illuminated with star marks as shown in FIG. 20A.

In contrast, when the nearby object detector 21 of the road surface illumination apparatus detects persons 101 in areas to the left and right of the vehicle 100, as shown in FIG. 20B, the illumination method determination unit 22 determines to illuminate each of areas to the left and right of the vehicle with a light animation. The illumination range setting unit 23 sets the illuminated range to road surfaces under the doors on the left and right sides of the vehicle in accordance with the determination. Therefore, each of the road surfaces under the doors on the right and left sides of the vehicle is illuminated with star marks as shown in FIG. 20B.

In this way, the road surface illumination apparatus can change the illuminated range of the light animation, and the expressing method, in accordance with nearby objects. As a result, the road surface illumination apparatus does not have to illuminate an area in any direction in which no nearby object is existing with a light animation, there is provided an advantage of preventing the whole town from being full of light. Further, there is provided an advantage of being able to illuminate an area in a direction in which a detected nearby object is existing with a light animation which is emphasized to be more noticeable, and illuminate the area in the direction with a light animation while limiting the illuminated range of the light animation to the area.

Further, when detecting a person as a nearby object, the road surface illumination apparatus can illuminate only an area in a direction in which the person is existing with a light animation which is directed to give the person a warm welcome, and provides an advantage of being able to emphasize the intention to give persons a warm welcome.

As mentioned above, the road surface illumination apparatus according to Embodiment 2 includes the nearby object detector 21 to acquire the information indicating the existence or non-existence and direction of a nearby object around the vehicle, and the illumination method determination unit 22 to determine a method of applying an animation in accordance with the nearby object information acquired by the nearby object detector 21, and the light animation setting unit 3a is configured so as to change the animation set in accordance with the motion of the vehicle, in accordance with the illumination method determined by the illumination method determination unit 22. For example, the light animation setting unit 3a makes the animation, with which a road surface in a direction in which a nearby object is existing is to be illuminated, more noticeable in accordance with the illumination method determined by the illumination method determination unit 22, and limits the range which is to be illuminated with the animation to a road surface in a direction in which a nearby object is existing. As a result, the road surface illumination apparatus does not have to perform the illumination in any direction in which no nearby object is existing, thereby preventing the whole town from being full of light. Further, the road surface illumination apparatus can illuminate an area in a direction in which a nearby object is existing with a more noticeable animation, or alternatively illuminate only the area in the direction with an animation.

Further, the light animation setting unit 3a according to Embodiment 2 can not only change the animation set in accordance with the motion of the vehicle, in accordance with the illumination method, but also change the animation set in accordance with the vehicle state, in accordance with the illumination method. As a result, the road surface illumination apparatus can illuminate only a road surface in a direction in which a person is existing with an animation, thereby being able to emphasize the intention to give persons a warm welcome.

While the present invention has been described in its preferred embodiments, it is to be understood that an arbitrary combination of two or more of the above-mentioned embodiments can be made, various changes can be made in an arbitrary component according to any one of the above-mentioned embodiments, and an arbitrary component according to any one of the above-mentioned embodiments can be omitted within the scope of the invention.

### INDUSTRIAL APPLICABILITY

Because the road surface illumination apparatus according to the present invention illuminates a road surface with a light animation expressing a motion which the vehicle is going to perform, the road surface illumination apparatus is suitable for use as a road surface illumination apparatus or the like that provides a notification of the motion of the vehicle to others outside the vehicle.

### REFERENCE SIGNS LIST

1 vehicle information acquisition unit, 2 vehicle motion predictor, 3, 3a light animation setter, 4, 4a illumination device, 21 nearby object detector, 22 illumination method determination unit, and 23 illumination range setting unit.

1. A road surface illumination apparatus comprising:
a vehicle information acquisition unit to acquire vehicle information from vehicle-mounted equipment mounted in a vehicle;
a vehicle motion predictor to predict a motion which said vehicle is going to perform from now on, in accordance with the vehicle information acquired by said vehicle information acquisition unit; and
a light animation setting unit to cause an illumination device mounted in said vehicle to illuminate a road surface ahead of said vehicle with said a light animation expressing forward travel of said vehicle when the motion predicted by vehicle motion predictor is the forward travel, said light animation setting unit predicting positions of said vehicle on a basis of vehicle information indicating a speed at which said vehicle moves forward, acquired by said vehicle information acquisition unit, and causing the light animation to disappear together with passage of a rear portion of said vehicle above the light animation.

2. The road surface illumination apparatus according to claim 1, comprising:
a nearby object detector to acquire information indicating existence or non-existence of an object and a direction of the object around said vehicle; and
an illumination method determination unit to determine an illumination method for the light animation in accordance with the information acquired by said nearby object detector, wherein
said light animation setting unit changes the light animation which is set in accordance with the motion of said vehicle, in accordance with the illumination method determined by said illumination method determination unit.

3. The road surface illumination apparatus according to claim 2, wherein said light animation setting unit makes the light animation with which a road surface in a direction in which said object is existing is to be illuminated, more noticeable in accordance with the illumination method determined by said illumination method determination unit.

4. The road surface illumination apparatus according to claim 2, comprising an illumination range setting unit to limit a range being illuminated with the light animation to a road surface in a direction in which said object is existing, in accordance with the illumination method determined by said illumination method determination unit.

5. The road surface illumination apparatus according to claim 1, wherein:
said vehicle motion predictor determines a state of said vehicle in accordance with the vehicle information acquired by said vehicle information acquisition unit; and
said light animation setting unit sets a light animation expressing the state of said vehicle determined by said vehicle motion predictor, and causes said illumination device to illuminate the road surface with the light animation expressing the state of said vehicle.

6. The road surface illumination apparatus according to claim 1, further comprising said illumination device.

7. A road surface illumination apparatus comprising:
a vehicle information acquisition unit to acquire vehicle information from vehicle-mounted equipment mounted in a vehicle; and
a light animation setting unit to cause an illumination device mounted in said vehicle to illuminate a road surface with a light animation providing to a nearby person a notification of a state indicating that said vehicle is capable of traveling after an engine of said vehicle has been started, when said vehicle information acquisition unit acquires the vehicle information indicating that the engine of said vehicle has been started.

8. The road surface illumination apparatus according to claim 1, further comprising said illumination device.

9. A method of illuminating a road surface, comprising:
acquiring vehicle information from vehicle-mounted equipment mounted in a vehicle;
predicting a motion which said vehicle is going to perform from now on, in accordance with the acquired vehicle information;
causing an illumination device mounted in said vehicle to illuminate a road surface ahead of said vehicle with a light animation expressing forward travel of said vehicle when the predicted motion is the forward travel;
predicting positions of said vehicle on a basis of vehicle information indicating a speed at which said vehicle moves forward, acquired from said vehicle-mounted equipment; and
causing the light animation to disappear together with passage of a rear portion of said vehicle above the light animation.

10. A method of illuminating a road surface, comprising:
acquiring vehicle information from vehicle-mounted equipment mounted in a vehicle; and
causing an illumination device mounted in said vehicle to illuminate a road surface with a light animation providing to a nearby person a notification of a state indicating that said vehicle is capable of traveling after an engine of said vehicle has been started, when acquiring the vehicle information indicating that the engine of said vehicle has been started.
